(19) United States
(12) Patent Application Publication
(10) Pub. No.: US 2011/0274983 A1
(43) Pub. Date: Nov. 10, 2011

(54) POLYMER ELECTROLYTES INCLUDING POROUS ORGANIC PARTICLES

(75) Inventors: Dorie J. Yontz, Midland, MI (US); Douglas A. Brune, Midland, MI (US); Stephanie L. Hughes, Beaverton, MI (US); Valeriy Ginzberg, Midland, MI (US); Susan J. Babinec, Midland, MI (US); Sudhakar Balijepalli, Midland, MI (US)

(73) Assignee: DOW GLOBAL TECHNOLOGIES LLC, Midland, MI (US)

(21) Appl. No.: 13/143,000

(22) PCT Filed: Feb. 10, 2010
(86) PCT No.: PCT/US10/23704

§ 371 Date: Jun. 30, 2011

Related U.S. Application Data
(60) Provisional application No. 61/151,604, filed on Feb. 11, 2009.

(51) Int. Cl. H01M 10/0565

(52) U.S. Cl. 429/309

(57) ABSTRACT

The present invention is directed to an electrolyte comprising a first phase including a porous organic microparticle; and a second phase including an ethylene oxide-containing polymer (i.e., an EOP); wherein the second phase is a continuous phase. The polymeric electrolyte compositions preferably also includes a lithium salt and optionally a solvent. The polymeric electrolyte composition may have a shear modulus, G′, measured at 1 rad/sec and about 30° C. and a conductivity, σ, measured at about 30° C., such that i) G′-σ is greater than about 200 (S/cm)(dynes/cm²); and ii) G′ is from about 10⁴ to about 10¹⁰ dynes/cm².

### CLAIM OF PRIORITY

The present application claims the benefit of U.S. Provisional Patent Application No. 61/151,604 (filed on Feb. 11, 2009) which is hereby incorporated by reference in its entirety for all purposes.

### FIELD OF THE INVENTION

The present invention is directed generally at multi-phase materials including ethylene oxide-containing polymers and organic particles, and particularly at materials that may be used as a solid polymeric electrolyte, for example as an ionically conductive layer between the electrodes in a battery that use organic microparticles.

### BACKGROUND OF THE INVENTION

Rechargeable batteries have received tremendous attention in recent years. Such batteries also have come to be known as “secondary batteries” or even as “storage batteries”. They can be operated to store a charge, and thereafter operated to discharge the charge to provide a source of electricity to a device. In general, these type of batteries have a small number of active components, which include the electrodes (specifically the anode and the cathode), which cooperate together to perform a reversible electrochemical reaction. In general, efforts to improve the performance (e.g., the durability and efficiency) of rechargeable batteries have concentrated in many instances upon the improvement of one of more of these active components.

One increasingly popular type of battery is a battery that employs a metal ion (e.g., a lithium-ion) in a generally cohesive mass of an electrolyte material. When an electrochemical cell of such a battery is discharging, generally lithium ions extracted from the anode flow to the cathode. When the cell is charging, the reverse process occurs. Lithium ions become extracted from the cathode and flow to and become inserted into the anode.

The use of single phase homogeneous materials generally have not sufficed for battery applications, due to the inability to achieve a desired balance of properties, such as electrical and mechanical properties. Efforts have been undertaken to explore materials systems suitable that have multiple distinct phases, with each phase contributing to improving a particular processing and/or performance characteristic of the material. Within the balance of mechanical and electrical properties there may be a number of specific competing considerations and needs. For example, for many applications it is important that the material provide a relatively cohesive mass, such as a solid, a gel, a paste, or the like, which retains a shape when not constrained (such as by a housing), and which can be readily handled without tearing, fracture or other failure. The material also desirably will permit for efficient ion mobility such as by providing a continuous flow path. Microstructure generally needs to be controlled such as for obtaining a generally uniform distribution of multiple phases. It is also important that the material be durable and withstand the dynamic thermal conditions to which it will be exposed. Phase compatibility during processing and thereafter also is a consideration. Flame retardancy is especially desired for certain applications. Though on its face an ostensibly straightforward task, it has proven to be very difficult to arrive at high performance electrolytes. Numerous competing considerations need to be addressed and the success of any particular proposed combination has been far from predictable.

To address some of the considerations, electrolytes having a plurality of phases (e.g., mixture of immiscible polymers, and mixtures of polymers with fillers or other solid particles) have been proposed. For example, efforts to improve the performance of electrolytes include the addition of inorganic particles (e.g., fillers) to the electrolyte, such as described by U.S. Pat. Nos. 4,534,996 (Rembaum et. al., issued on Aug. 13, 1985), 5,009,971 (Johnson et. al., issued on Apr. 23, 1991), and 6,395,419 (Kuwahara et. al. issued May 28, 2002), and U.S. patent application Ser. No. 10/788,284 (Inoue et. al., filed on Mar. 1, 2004), all incorporated herein by reference in their entirety. Other efforts include the addition of a second polymer phase (e.g., solid polymer particles having relatively low polarity) to the electrolyte, such as those described by U.S. Pat. Nos. 5,585,039 (Matsumoto et. al., issued on Dec. 17, 1996) and 5,609,795 (Matsumoto et. al., issued on Mar. 11, 1997), both incorporated herein by reference in their entirety.

The general concept of employing organic microparticles as a way to address the competing needs of battery electrolytes may seem a straightforward solution. But efforts to use these materials have been erratic and unsuccessful. For example, certain organic microparticles have been evaluated in electrolyte compositions but have exhibited difficulties such as insufficient mechanical characteristics or have not achieved the electrical conductivity (e.g., the ionic conductivity) required for battery applications.

Notwithstanding efforts to date, until the present invention, there has been a need for an improved electrolyte material, particularly one that meets some or all of the needs for an electrolyte material such as having good mechanical and electrical characteristics, an attractive balance of electrical and mechanical characteristics, the capability of being handled substantially as a solid material, the physical state of a relatively cohesive mass, a relatively high shear modulus, good processability, the ability to be readily handled without failure, efficient ion mobility, high electrical conductivity (e.g., ionic conductivity), a continuous flow path (such as for an ion), a generally uniform distribution of multiple phases, good durability, low corrosivity of the composition of the electrolyte material, good ability to withstand the dynamic thermal conditions to which it will be exposed, or relatively good flame retardancy. Such electrolyte materials may be particularly advantageous for use in a secondary battery, in a device that is free of a porous separator, or both.

### SUMMARY OF THE INVENTION

In its various aspects, the present invention meets the above needs and overcomes various disadvantages of the prior art by the realization of unpredictable characteristics of organic particles attractive for use in a rechargeable battery, such as in a solid polymeric electrolyte. Accordingly, one first aspect of the invention is directed at an electrolyte comprising a first phase including a porous organic microparticle; and a second phase including an ethylene oxide-containing polymer (i.e., an EOP); wherein the second phase is a continuous phase, and the organic microparticles are hollow, porous, or both.

As a result of the various advantages that may be realized from the electrolyte compositions herein, they lend themselves to a number of useful applications. For example, a secondary battery may include a polymeric electrolyte composition as disclosed herein. The electrolyte compositions may also be used in a device that is free of a porous separator.

Another aspect of the invention is directed at a process for preparing an electrolyte composition (e.g., an polymeric electrolyte composition described herein) wherein the process includes the step of mixing: i) an organic microparticle that includes a styrene-containing polymer having a glass transition temperature, T_{gs}; ii) ethylene oxide-containing polymer; and iii) a lithium salt; wherein the organic microparticle is maintained at a temperature less than T_{gs} (e.g., less than about T_{gs}-10° C., or less than about T_{gs}-25° C.).

As will be seen from the teachings herein, the present invention reflects a surprising approach and solution to tackling the problems heretofore faced in the art, which has been limited due to previously, irreconcilable tradeoffs in electrical and mechanical properties needed for battery applications. The polymeric electrolyte compositions of the present invention have a surprising balance of high melting temperature or glass transition temperature, high electrical conductivity (e.g., ionic conductivity), and high stiffness that make them particularly useful as an ionically conductive material for battery cells.

The polymeric electrolyte compositions of the present invention exhibit an unexpected balance of characteristics including for instance, two, three, four, or more (e.g., a combination of all) characteristics such as the capability of being handled substantially as a solid material, electrical performance heretofore expected only from liquid electrolytes, a relatively high electrical conductivity (e.g., ionic conductivity), a relatively high shear modulus, relatively good proccessability, relatively good mechanical characteristics, the physical state of a relatively cohesive mass, the ability to be readily handled without failure, efficient ion mobility, a continuous flow path for metal ions, a generally uniform distribution of multiple phases, relatively high durability, relatively good ability to withstand the dynamic thermal conditions to which it will be exposed, or relatively good flame retardancy.

### BRIEF DESCRIPTION OF THE DRAWINGS

FIG. 1. Illustrates components in an illustrative secondary battery cell having a separator.

FIG. 2. Illustrates components in an illustrative secondary battery cell which is free of a separator.

### DETAILED DESCRIPTION OF THE INVENTION

The present invention is directed at an electrolyte, and particularly a substantially cohesive electrolyte material having strength, electrical, and other characteristics especially attractive for use in a battery.

Among its various aspects, the present invention is predicated upon the recognition, contrary to the expected outcome, of the unexpected discovery that the addition of organic particles, typically regarded as non-conducting, into electrolyte compositions, which includes a polyethylene oxide-containing polymer (EOP), surprisingly increases the shear modulus, the electrical conductivity (e.g., the ionic conductivity) of the electrolyte, or even both. The electrolytes are thus such that they preferably exhibit a surprisingly good combination of a relatively high electrical conductivity and a relatively good mechanical properties such as a relatively high shear modulus.

It is believed that the electrolytes herein unexpectedly realize their properties through the use of at least one unique organic microparticle that is hollow, porous, or both; and an ethylene oxide-containing polymer. When combined with a metal salt, such as a lithium salt, and optionally a solvent, an admixture of the at least one organic microparticle and the ethylene oxide-containing polymer is such that the metallic ion of the salt effectively can function as a mobile phase in the polymeric electrolyte composition. It thus can carry charge in a battery, while still desirably exhibiting mechanical properties that lends the material to easy handling as a relatively cohesive mass.

The polymeric electrolyte composition preferably is a heterogeneous material having distinct and separate phases (e.g., different polymeric phases). In particular it will include at least one first structural phase (i.e., one or more structural phases) that contributes as one of its primary functions to the mechanical, durability, and thermal stability of the material and at least one second phase that contains as one of its primary functions the electrical performance of the material. As will be seen, the first phase generally will include a first component (i.e. the organic microparticles) while the second phase will generally include some or all of the EOP (e.g., it may be rich in the EOP). The organic microparticles and the EOP are generally immiscible relative to each other, but, nonetheless are employed as an admixture to realize the advantages and benefits herein. When combined with the metal salt, and preferably with the solvent, the second phase preferably defines a substantially continuous phase, which when placed between two electrodes, can help to provide an efficient path for ions to migrate.

The benefits of the polymeric electrolyte compositions herein may be attained advantageously using readily available materials, particularly the ethylene-oxide containing polymer for the second phase (e.g., which may be a polyethylene oxide homopolymer), such that the polymeric electrolyte may be substantially or even entirely free of polymers requiring a plurality of (typically expensive) synthesis steps, such as required in forming a graft copolymer or other block copolymer.

### First Phase

The first phase generally will include an organic particle phase, such as at least one, and preferably a plurality of organic microparticles. The organic microparticles preferably have a relatively high melting temperature or a relatively high glass transition temperature such that the first phase is in a solid state (e.g., a semi-crystalline state, or a glassy state) at the typical use temperature of the electrolyte. By way of example, the first phase may be in a solid state at use temperatures up to about 60° C. The first phase preferably is present at a sufficient amount so that the electrolyte composition can generally be handled as a solid. The first phase may be present at a concentration greater than about 5 weight percent, preferably greater than about 10 weight percent, more preferably greater than about 20 weight percent, and most preferably greater than about 25 weight percent, based on the total weight of the electrolyte composition, such that the first phase provides strength and stiffness to the polymeric electrolyte composition. The first phase preferably is present at an amount sufficiently low so that the second phase is a continuous phase. The first phase may be present at a concentration less than about 70 percent, preferably less than about 50 percent, more preferably less than about 45 percent by volume, and most preferably less than about 35 percent based on the total volume of the polymeric electrolyte composition (e.g., the second phase and the first phase).

The first phase may include an organic polymer, such that the polymer, the first phase, or both have a modulus (e.g., an elastic modulus) greater than the modulus of the second phase (e.g., the second phase including the polyethylene oxide-containing polymer, the metal salt, and the optional solvent), greater than the modulus of the polymer in the second phase (e.g., the polyethylene oxide-containing polymer), or both. For example, the first phase may include, consist essentially of, or even consist of one or more polymers having an elastic modulus greater than about 0.4 GPa, preferably greater than 0.7 GPa, more preferably greater than about 1.2 GPa, and most preferably greater than about 1.8 GPa. Without limitation, the first phase may include a polymer selected from high density polyethylene, medium density polyethylene, low density polyethylene, linear low density polyethylene, isotactic polypropylene, polypropylene random copolymers, atactic polystyrene homopolymer, syndiotactic polystyrene homopolymer, polystyrene random copolymers including at least 90 mole percent styrene monomer, polystyrene block copolymers including at least 40 weight percent styrene blocks, high impact polystyrene, polyethylene terephthalate, polybutylene terephthalate, polymethyl methacrylate, or polyisbutyl methacrylate, or any combination thereof. Preferred polymers include polymers having or consisting of one or more ethylenically unsaturated monomeRs. Preferred polypropylene random copolymers include polypropylene copolymers containing propylene at a concentration of about 80 percent or more, more preferably about 90 percent or more, and most preferably about 94 mole percent or more, based on the total moles of monomers in the copolymer; having a crystallinity of at least 30 weight percent as measured by differential scanning calorimetry, or both. Preferred polystyrene block copolymers including about 25 weight percent or more styrene blocks, more preferably about 20 weight percent or more styrene blocks, based on the total weight of the block copolymer. For example, the polymer may includes a styrene-containing polymer, such as a styrene-butadiene block copolymer, a styrene-isoprene block copolymer, a polystyrene homopolymer, a polystyrene random copolymer a high impact polystyrene, a styrene-acrylonitrile block copolymer, an acrylonitrile-butadiene-styrene block copolymer, hydrogenated and partially hydrogenated analogues of the above isoprene and butadiene containing copolymers, or any combination thereof. Styrene-containing polymer includes atactic polystyrenes, such as atactic polystyrene homopolymer or copolymers, and block copolymer including one or more blocks of atactic polystyrene. Other styrene-containing polymers includes syndiotactic polystryrene, such as syndiotactic polystyrene homopolymer or copolymers, and block copolymers having one or more blocks of syndiotactic polystyrene. Preferred polystyrene homopolymers include polystyrenes having a final melting temperature of about 240° C. or more, as measured by differential scanning calorimetry. Preferred polymers include those having a weight average molecular weight of about 20,000 Daltons or more, more preferably about 50,000 Daltons or more. The polymer may have a weight average molecular weight less than about 20,000,000 Daltons, preferably less than about 5,000,000 Daltons, and more preferably less than about 2,000,000 Daltons. The elastic modulus, of a variety of polymers are listed in R. W. Warfield, and F. R. Barnet, “Elastic constants of Bulk Polymers”, Naval Ordnance Laboratories, White Oak, Silver Spring, Md., NOLTR 71-226, Apr. 12, 1972, page 2. For purposes of illustration, the approximate elastic modulus (i.e., Young's Modulus), measured at a temperature of about 25° C., of exemplary homopolymers which may be used for the second phase or the first phase are shown below in TABLE 1.

TABLE 1

| Polymer | Elastic Modulus, GPa |
|---|---|
| Polystyrene | 3.43 |
| Polymethyl methacrylate | 3.01 |
| Polyisobutyl methacrylate | 1.49 |
| Poly-4-methyl pentene-1 | 1.59 |
| Polyethylene (HDPE) | 0.88 |
| Polypropylene (isotactic) | 1.42 |
| Polyethylene oxide | 0.29 |

Polymers of the above type that are used herein may vary from the stated modulus (e.g., +/− about 30 percent, or even +/− about 50 percent). The elastic modulus of the polymer of the particles in the first phase may be at least 2×, 3×, or even at least 5× (e.g., at least about 10×) that of the polymer of the second phase.

The first phase preferably is a solid phase with relatively poor ionic conductivity as compared to the second phase. As such, it is preferable that the metal salt and the optional solvent is included in the second phase and predominantly excluded from the first phase. Preferably the first phase is essentially free of the metal salt. If present in the first phase, the amount of the metal salt that is in the first phase may be less than about 30 percent, preferably less than about 20 percent, more preferably less than about 10 percent, and most preferably less than about 5 percent based on the total concentration of the metal salt. Preferably the first phase is essentially free of the optional solvent, If present in the first phase, the amount of the solvent in the first phase may be less than about 30 percent, preferably less than about 20 percent, more preferably less than about 10 percent, and most preferably less than about 5 percent based on the total concentration of the solvent. The second phase is preferably rich in the metal salt. The second phase is preferably rich in the solvent, if present. The second phase is preferably rich in the EOP A second phase that is rich in ingredient i means that the ratio of vᵢ₂/vᵢ₁ is greater than 1, where vᵢ₂ is the volume fraction of ingredient i in the second phase, based on the total volume of second phase, and vᵢ₁ is the volume fraction of ingredient i in the first phase, based on the total volume of the first phase. Preferably a second phase that is rich in ingredient i has a ratio of vᵢ₂/vᵢ₁ of about 1.5 or more, more preferably about 2 or more, even more preferably about 5 or more, and most preferably about 10 or more.

The shear modulus of the first phase (e.g., of the organic microparticles) preferably is higher than the shear modulus of the second phase. The shear modulus of the two phases may be determined by preparing separate samples, one having the composition of the second phase and another have a composition of the first phase and then measuring the shear modulus of the two bulk samples. Thus prepared, the ratio of the shear modulus of the first phase to the shear modulus of the second phase may be about 1.1 or more, preferably about 1.5 or more, even more preferably about 2.0 or more, even more preferably about 2.5 or more, and most preferably about 3.0 or more.

The electrolyte may be prepared so that the first phase effectively defines a “superstructure” that includes clusters (e.g., agglomerations) of the organic particles. A superstructure may be any arrangement of 2 or more generally interconnected particles. The clusters may be relatively small (e.g., about 2 to about 20 particles), moderate in scale (e.g., more than about 20 to about 50 particles) or it may be quite large (e.g., more than about 50, about 200 or more, or even about 1000 or more particles. The superstructures may be sufficiently large that the first phase is further characterized as having a continuous structure in one, two, or even three dimensions.

The organic particles may be solid particles, particles that are porous (e.g., particles having a porous shell), particles that are hollow (i.e., voided), or particles that are both hollow and have a porous shell. Preferred particles are porous, hollow, or both. More preferred particles are both porous and hollow. For example, the hollow organic particles may be voided particles which have a contiguous shell (i.e., it may be a hollow, non-porous particle) or a porous shell (i.e., it may be a hollow, porous particle). The organic particle may be a latex particle. Without limitation, the organic particle may be based on encapsulated and expanded acid or ester core particles. Examples of preferred particles and their preparation are described in U.S. Pat. No. 5,157,084 (D. I. Lee et. al., issued Oct. 20, 1992), U.S. Pat. No. 4,427,836 (A. Kowalski et. al., issued Jan. 24, 1984), and International Patent Application Publication No. WO2008/067444 (Keefe et. al., filed on Nov. 29, 2007), all of which are expressly incorporated herein by reference in their entirety.

The organic particle may be prepared by an emulsion polymerization process as described by Kowalski et. al., U.S. Pat. No. 4,427,836, column 3, line 12 through column 9, line 2, incorporated herein by reference. Additional organic particles that may be used in the present invention include a hollow particle formed from a latex having a swellable core as described by Lee et. al, U.S. Pat. No. 5,157,084, column 2, line 12 through column 6, line 24, incorporated herein by reference. The organic particle may be a particle having an average void fraction greater than about 0.6 as described by Keefe et al. (PCT Patent Application Publication No. WO2008/067444A1, filed on Nov. 29, 2007) page 2, line 19 through page 12, line 27, incorporated herein by reference.

When organic particles are used in a first phase herein, they are preferably sized and/or used in an amount to allow the formation of clusters of adjoining particles, or to otherwise avoid deterioration of electrical conductivity (e.g., the ionic conductivity) of the overall material.

Advantageously, the organic particles may be hollow porous particles, hollow non-porous particles, or both, such that they have an average polymer fraction f_{polymer}, and an average void fraction (i.e., wet void fraction), f_{void}, where f_{polymer}+f_{void}=1. The organic particles may be characterized by a relatively high average void fraction (e.g., a high average wet void fraction), f_{void}. The average void fraction may be measured according to the method described later herein in the section labeled “Test Methods”. The average void fraction preferably is about 0.1 or more, more preferably about 0.3 or more, even more preferably about 0.4 or more, and most preferably about 0.5 or more. The void fraction preferably is about 0.99 or less, more preferably about 0.8 or less, and most preferably about 0.7 or less. It will be appreciated that relatively high values of the void fraction may also be desirable. For example the void fraction may be about 0.6 or more, about 0.7 or more, or about 0.75 or more.

The organic particles are formed of a polymeric material including or consisting essentially of the one or more polymers of the first phase, such as the polymers described hereinbefore for the first phase.

At the use temperature of the electrolyte, the organic particles preferably remain in a solid state. The organic particles preferably include, consists essentially of, or even consists entirely of one or more polymers having a solid to liquid transition temperature of about 60° C. or more, more preferably about 80° C. or more, even more preferably about 90° C. or more, and most preferably about 100° C. or more. The solid to liquid transition temperature may be a melting temperature or a glass transition temperature. Particles which have a glass transition temperature of about 60° C. or less may be used if they are semi-crystalline polymers. Preferred semi-crystalline polymers have a crystallinity of about 20 weight percent or more, preferably about 30 weight percent or more, even more preferably about 40 weight percent or more, and most preferably about 50 weight percent or more.

The organic particles should have a size so that they can be dispersed in the first phase, so that thin films of the polymeric electrolyte material can be made, or both. Preferred organic particles may have a median, mean (i.e., D_{w}), or even top (i.e., largest) particle size of about 100 μm or less, preferably about 20 μm or less, more preferably about 10 μm or less, and most preferably about 5 μm or less. The organic particles preferably have a median, mean, or even top particle size of about 10 nm or more, more preferably about 50 nm or more, and most preferably about 100 nm or more. As used herein, “median particle size” refers to the volume median diameter measured and “mean particle size” refers to the volume mean diameter, measured by hydrodynamic chromatography. The distribution of particle sizes may be monomodal or multi-modal. By way of example, the organic particles may have a generally monomodal distribution wherein the distribution (e.g., the volume fraction as a function of the diameter) may have a single peak. Alternatively the distribution of particle sizes may be multi-modal, such as by the combination of two or more distributions each characterized as being monomodal. By way of example, a multi-modal distribution of particle sizes may be a bimodal distribution. A preferred bimodal distribution has two peaks in the distribution of particle sizes as measured by the volume fraction of particles as a function of diameter of particles. When dispersed in the first phase, the organic particles may be discrete particles, or may form an agglomeration of particles. An agglomeration of particles may be a one-dimensional, two-dimensional, or three-dimensional agglomeration. A one dimensional agglomeration may be characterized as a linear or curvilinear assembly of particles. A three-dimensional agglomeration may be characterized as an assembly of particles that forms a network having a plurality of paths along the agglomeration between at least two particles of the agglomeration. An agglomeration of particles may be characterized as a two-dimensional agglomeration if it is not a network (e.g., does not have a plurality of paths along the agglomeration between at least two particles of the agglomeration) of particles and has at least one particle that is interconnected with three or more other particles. As an illustrative example, the organic particles may have D_{w} of about 1 μm or less; and form an agglomeration spanning a distance of about 10 μm or more, or about 50 μm or more, in one, two or even three directions.

The organic particles may be provided in any convenient form, such as a powder, a slurry or paste, a concentrate (e.g., in a polymer, such as an EOP), or a latex. For example, the organic particles may be provided as a latex containing water at a concentration of about 10 weight percent or more, preferably about 20 weight percent or more, more preferably about 30 weight percent or more, and even more preferably about 40 weight percent or more, and most preferably about 50 weight percent or more. The concentration of water in the latex preferably is about 99 weight percent or less, more preferably about 90 weight percent or less, and most preferably about 80 weight percent or less. Preferred latexes may have a solids content of about 90 weight percent or less, preferably about 80 weight percent or less, more preferably about 70 weight percent or less, even more preferably about 60 weight percent or less, and most preferably about 50 weight percent or less. Preferred latexes may have a solids content of about 1 weight percent or more, more preferably about 10 weight percent or more, and most preferably about 20 weight percent or more. If a latex is employed, the ratio of the latex to the EOP may be about 5:1 or less, preferably about 2:1 or less, more preferably about 3:2 or less. and most preferably about 1:1 or less, such that the amount of water is kept to a minimum.

Without limitation, illustrative porous organic particles include polystyrene porous microparticles, such as polystyrene latex porous microparticles.

### Second Phase

The second phase may be present in any concentration such that the second phase is a continuous phase. The second phase preferably provides a continuous ionic conductivity path. Preferably, the second phase is present at a concentration (in volume percent) of about 20 percent or more, more preferably about 30 percent or more, even more preferably about 40 percent or more, even more preferably about 45 percent or more, and most preferably about 60 percent or more, based on the total volume of the first and second phases. The second phase preferably is present at a concentration (in volume percent) of about 95 percent or less, more preferably about 85 percent or less, and most preferably about 80 percent or less, based on the total volume of the first and second phases.

The second phase includes the ethylene oxide-containing polymer outside of the microparticles and any ethylene oxide-containing polymer that is in the interior of the microparticles. In other words, the second phase includes any EOP that has filled the pores and/or voids of the microparticles, such as the microparticles that are porous, hollow, or both.

### Ethylene Oxide-Containing Polymer

Turning now to the polymer of the second phase of the polymeric electrolyte, the second phase preferably includes one or more polymers which can be doped with relatively high concentrations of one or more metal salts, and have relatively good metal ion conductivity when doped. By way of example, when doped with one or more lithium salts, the second phase preferably has good lithium ion conductivity. The polymer of the second phase preferably includes, consists essentially of or even consist entirely of one or more ethylene-oxide containing polymers (i.e., EOP). Preferably the polymer of the second phase includes one or more EOPs at a concentration of about 50 weight percent or more, more preferably about 60 weight percent or more, even more preferably about 75 weight percent or more, and most preferably about 95 weight percent or more, based on the total weight of the polymer of the second phase, The EOP may be a polyethylene oxide homopolymer, an ethylene oxide copolymer or any combination thereof. Examples of ethylene oxide copolymers include block copolymers and random copolymers. Ethylene oxide copolymers include copolymers having a first monomer, namely ethylene oxide, and one or more second monomers. The second monomers may be one or more alkylene oxides having at least 3 carbon atoms, allyl glycidyl ether, alkyl glycidyl ether (e.g., methyl glycidyl ether), or any combination thereof. Preferred alkylene oxides for use in the second monomer include propylene oxide, butylene oxide, and combinations thereof. Preferred alkyl glycidyl ethers for use in the second monomer include methyl glycidyl ether, ethyl glycidyl ether, propyl glycidyl ether, and butyl glycidyl ether. Preferably the second monomer includes propylene oxide, butylene oxide, methyl glycidyl ether or any combination thereof. More preferably the second monomer includes, consists essentially of, or even consists of propylene oxide.

Advantageously, the ethylene oxide-containing polymer includes a sufficiently high concentration of ethylene oxide, so that the metal ion conductivity of the doped polyethylene oxide-containing polymer is realized in sufficient amount to make it suitable for a battery application. Without being bound by theory, a high ethylene oxide concentration may improve the conductivity of an electrode containing a metal salt, electroactive particles, a solvent, or any combination thereof. Preferred ethylene oxide-containing copolymer may have an ethylene oxide mole fraction, X_{EO} of about 0.80 or more, more preferably about 0.85 or more, even more preferably about 0.90 or more, even more preferably about 0.94 or more, even more preferably about 0.94 or more, and most preferably about 0.95 or more, based on the total moles of monomer in the copolymer. Preferred ethylene oxide-containing copolymers may contain a molar fraction of ethylene oxide of about 0.995 or less, more preferably about 0.98 or less, even more preferably about 0.97 or less, and most preferably about 0.96 or less, based on the total moles of monomer in the copolymer.

If employed, the second monomer preferably is present at a molar fraction of about 0.20 or less, more preferably about 0.15 or less, even more preferably about 0.10 or less, and most preferably about 0.06 or less, based on the total moles of monomer in the copolymer. If employed, the second monomer preferably is present at a molar fraction of about 0.05 or more.

The EOP may be an ethylene oxide homopolymer which is essentially free, or even entirely free of monomers other than ethylene oxide, such as a second monomer. If the ethylene oxide homopolymer includes a monomer other than ethylene oxide, it will preferably be present at a mole fraction of about 0.035 or less, more preferably about 0.03 or less, even more preferably 0.01 or less, and most preferably about 0.002 or less.

The EOPs may include polymers having a crystalline portion. Preferable EOPs have a relatively low crystallinity (e.g. as measured using differential scanning calorimetry). Preferably, the ethylene oxide-containing copolymer has a crystallinity of about 80 weight percent or less, more preferably about 70 weight percent or less, even more preferably about 50 weight percent or less, even more preferably about 40 weight percent or less, and most preferably about 35 weight percent or less.

The EOP preferably is a polymer having a sufficient molecular weight so that it can form a network of physical cross-links or entanglements. The EOP preferably has a weight average molecular weight (as measured for example by gel permeation chromatography) of about 1,000 Daltons or more, more preferably about 10,000 Daltons or more, and most preferably about 20,000 Daltons or more. The EOP preferably has a weight average molecular weight of about 2,000,000 Daltons or less, more preferably about 600,000 Daltons or less, and most preferably about 300,000 Daltons or less.

### Salt

The materials herein may include one or more salts having a cation that is mobile in the polymeric electrolyte composition, that is capable of carrying a charge, or both. The materials herein (e.g., the polymeric electrolyte compositions) preferably include one or more salts which may be a solid or a liquid (e.g., an ionic liquid) at room temperature. A single salt or a mixture of two or more different salts may be used. The salt may include or consist essentially of one or more inorganic salts. By way of example, the inorganic salt may include a salt having a metallic cation (i.e., a metal salt), a salt that is fee of metallic cations (such as in an ammonium salt), or a combination thereof. Any metal or combination of metals may be employed in the metal salt. Preferred metal salts includes alkali metal salts and alkaline earth metal salts. By way of example, the metal salt may include lithium, sodium, beryllium, magnesium, or any combination thereof. A particularly preferred metal salt is a lithium salt. Without limitation, the lithium salt may include, consist substantially of, consist essentially of, or even consist of lithium trifluoromethane sulfonate (lithium triflate or LiCF₃SO₃), lithium hexafluorophosphate (LiPF₆), lithium hexafluoroarsenate (LiAsF₆), lithium imide (Li(CF₃SO₂)₂N), lithium tris(trifluoromethane sulfonate) carbide (Li(CF₃SO₂)₃C), lithium tetrafluoroborate (LiBF₄), LiBF, LiBr, LiC₆H₅SO₃, LiCH₃SO₃, LiSbF₆, LiSCN, LiNbF₆, lithium perchlorate (LiClO₄), lithium aluminum chloride (LiAlCl₄), LiB(CF₃)₄, LiBF(CF₃)₃, LiBF₂(CF₃)₂, LiBF₃(CF₃), LiB(C₂F₅)₄, LiBF(C₂F₅)₃, LiBF₂(C₂F₅)₂, LiBF₃(C₂F₅), LiB(CF₃SO₂)₄, LiBF(CF₃SO₂)₃, LiBF₂(CF₃SO₂)₂, LiBF₃(CF₃SO₂), LiB(C₂F₅SO₂)₄, LiBF(C₂F₅SO₂)₃, LiBF₂(C₂F₅SO₂)₂, LiBF₃(C₂F₅SO₂), LiC₄F₉SO₃, lithium trifluoromethanesulfonyl amide (LiTFSA), or any combination thereof. Combinations of lithium salts may also be used. Similarly, any of the above salts may also be combined with a different salt, such as a different metal salt, or even with a salt that is free of a metallic cation (such as an ammonium salt). If employed, the one or more lithium salts may be some or all of the salt in the polymeric electrolyte composition. Preferably, the concentration of the lithium salt (such as the concentration of any one or any combination of the above lithium salts) is about 30 weight percent or more, more preferably about 50 weight percent or more, even more preferably about 70 weight percent or more, even more preferably about 95 weight percent or more, and most preferably about 98 weight percent or more, based on the total weight of the inorganic salt. One particularly preferred lithium salt is a lithium salt that includes lithium triflate. Preferably the inorganic salt, the lithium salt, or both includes lithium triflate at a concentration of about 95 weight percent or more, and more preferably about 98 weight percent or more. Most preferably the inorganic salt, the lithium salt, or both, consists essentially of, or consists entirely of lithium triflate.

The metal salt should be present at a concentration sufficiently high so that metal ions can be transported by the polymeric electrolyte. The metal salt (e.g., the lithium salt) preferably is present in the polymeric electrolyte composition at a concentration of about 0.5 weight percent or more, more preferably about 1.0 weight percent or more, and most preferably about 1.5 weight percent or more, based on the total weight of the electrolyte composition, based on the total weight of the second phase, or both. The metal salt (e.g., the lithium salt) preferably is present in the polymeric electrolyte composition at a concentration of about 30 weight percent or less, more preferably about 20 weight percent or less, and most preferably about 15 weight percent or less, based on the total weight of the polymeric electrolyte composition, based on the total weight of the second phase, or both

The ratio of the molar concentration of oxygen atoms (e.g. moles of —C═O, C—O—C, and —C—OH groups, where C refers to carbon atoms, O refers to oxygen atoms and H refers to hydrogen atoms) from the polymer of the second phase (e.g., the EOP polymer) to the molar concentration of metal anions (e.g., moles of M+) from the metal salt (i.e., the O:M ratio). For lithium salt, the O:LI ratio is the ratio of the molar concentration of oxygen atoms from polymer of the second phase (e.g., the EOP polymer) to the molar concentration of Li ions from the lithium salt. Preferably the O:M ratio (e.g., the O:Li ratio) is about 1:1 or more, more preferably about 2:1 or more, even more preferably about 4:1 or more, and most preferably about 10:1 or more. Preferred electrolyte compositions have an O:M ratio (e.g, an O:Li ratio) of about 120:1 or less, more preferably about 80:1 or less, even more preferably about 60:1 or less, even more preferably about 40:1 or less, and most preferably about 30:1 or less. By way of example, the O:M ratio (e.g., the O:Li ratio) of the electrolyte composition may be about 10, about 15, about 20, or about 25. In determining the O:M ratio, the O:Li ratio, or both, the oxygen in the polymer in the first phase (e.g., the polymer in the organic particles) preferably is not included when calculating the molar concentration of oxygen atoms.

### Solvent

Composition herein may further comprise a solvent or carrier, referred to collectively as solvent. The solvent may selected so that the mobility of a cation in the second phase of the polymeric electrolyte composition is increase, so that the glass transition temperature of the second phase of the polymeric electrolyte composition decrease, so that the crystallinity of the second phase of the polymeric electrolyte composition decreases, or any combination thereof. The solvent may be a solid or liquid at a temperature of about 25° C. Preferred solvents are liquids at a temperature of about 25° C.

Particularly preferred solvents may be characterized by a relatively high dielectric constant. Without limitation, exemplary solvents may have a dielectric constant greater than about 15, preferably greater than 27, more preferably greater than 50 and most preferably greater than about 66. Dielectric constants may be measured for example using the methodology of ASTM D150.

In one aspect of the invention, the solvent includes a solvent that is characterized as a mono-hydroxy-terminated ethylene oxide-based ligands, an organophosphate, or both. The solvent preferably includes, or consists essentially of an aprotic solvent, which may be anhydrous. By “anhydrous” it is meant that the solvent as well as the electrolyte composition material comprises water at a concentration of about 1,000 ppm (parts per million by weight) or less, preferably about 500 ppm or less, and more preferably about 100 ppm or less. Preferred aprotic solvents for forming the polymeric electrolytel comprise at least one member selected from the group consisting of organic aprotic carriers or solvents, organic sulfites, organic sulfones, organic carbonates, organic esters, organic ethers, their fluorinated derivatives, and any combination thereof. Preferred organic esters include lactones and acetates.

The solvent preferably is an organic solvent. A preferred solvent includes or consists essentially of one or more cyclic carbonates, one or more acyclic carbonates, or one more fluorine containing carbonates, one or more cyclic esters, or any combination thereof. Acyclic carbonates include linear acyclic carbonates. Without limitation, examples of solvent may include cyclic carbonates, preferably including ethylene carbonate (EC), propylene carbonate (PC), fluoroethylene carbonate (FEC), and butylene carbonate (BC). Additional examples may include a cyclic carbonate having a C═C unsaturated bond, such as vinylene carbonate (VC), vinylethylene carbonate (VEC), divinylethylene carbonate, phenylethylene carbonate, diphenyethylene carbonate, or any combination thereof.

Examples of linear acyclic carbonates such as dimethyl carbonate (DMC), ethylmethyl carbonate (EMC), diethyl carbonate (DEC), dipropyl carbonate (DPC), methylpropyl carbonate (MPC), ethyl propyl carbonate (EPC), and methylbutyl carbonate may also be used alone or in combination. Examples of a linear carbonate having a C═C unsaturated bond include methyl vinyl carbonate, ethyl vinyl carbonate, divinyl carbonate, allyl methyl carbonate, allyl ethyl carbonate, diallyl carbonate, allyl phenyl carbonate, diphenyl carbonate, or any combination thereof.

Other carbonates which may be used include fluorine containing carbonates, including difluoroethylene carbonate (DFEC), bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, or any combination thereof.

Exemplary cyclic esters include γ-butyrolactone (γ-BL), α-methyl-γ-butyrolactone, γ-valerolactone; or any combination thereof. Examples of a cyclic ester having a C═C unsaturated bond include furanone, 3-methyl-2(5H)-furanone, α-angelicalactone, or any combinations thereof.

Other solvents which may be used include fluorinated oligomers, dimethoxyethane, triethylene glycol dimethyl ether (i.e., triglyme), tetraethyleneglycol, dimethyl ether (DME), polyethylene glycols, bromo γ-butyrolactone, fluoro chloroethylene carbonate, ethylene sulfite, propylene sulfite, phenylvinylene carbonate, catechol carbonate, vinyl acetate, dimethyl sulfite, or any combination thereof. Among these solvents, EC, PC and γ-BL are preferred, and PC is most preferred. The concentration of the carbonate solvent (e.g., the concentration of EC, PC, γ-BL, or any combination thereof) preferably is about 50 weight percent or more, more preferably about 75 weight percent or more, even more preferably about 90 weight percent or more, and most preferably about 95 weight percent or more, based on the total weight of the organic solvent.

The solvent may include, consist substantially of (e.g., at least about 95 weight percent based on the total weight of the solvent), or even consist of one or more mono-hydroxy-terminated ethylene oxide-based ligands such as di(ethylene glycol) monomethyl ether. Such a solvent may be an organophosphate. Without limitation, one exemplary organophosphate which may be used is O═P(OC₂H₄OC₂H₄OCH₃)₃. Analogues containing propylene oxide, a combination of propylene oxide and ethylene oxide, a monoethyl ether, a monobutyl ether, a monopropyl ether, from 3 to 5 alkoxide groups, or the like may also be used. One approach contemplates selecting and employing a solvent so that flame retardancy of the polymeric electrolyte is managed. For example, it is possible to employ an organophosphate of a type an amount sufficient to improve the flame retardant characteristics of the electrolyte compared to a similarly prepared electrolyte in which the organophosphate is eliminated. An improvement in the flame retardant characteristics of the electrolyte may be characterized by a reduction in the horizontal burn rate (e.g., a reduction of at least 20 percent) as measured by ASTM D635; an increase in the oxygen index (e.g., an increase in the oxygen index by at least 1 percent on an absolute basis) as measured for example according to ASTM D2863; an increase in the flash point (e.g., an increase of about 10° C. or more, preferably an increase of about 20° C. or more) as measured by the Cleveland Open Cup method ASTM D92; or any combination thereof. By way of example the organophosphate may be O═P(OC₂H₄OC₂H₄OCH₃)₃. The organophosphate, if employed, should be used at a concentration sufficient to improve the flame retardant characteristics of the electrolyte. If employed, the organophosphate preferably is present in an amount of about 1 weight percent or more, more preferably about 5 weight percent or more, even more preferably about 10 weight percent or more, even more preferably about 15 weight percent or more, and most preferably about 30 weight percent or more, based on the total weight of the electrolyte composition. If employed the organophosphate preferably is present in an amount of about 60 weight percent or less, preferably about 50 weight percent or less, and most preferably about 40 weight percent or less, based on the total weight of the electrolyte composition.

Electrolyte compositions which do not contain solvent and include EOPs as described herein may have relatively low electrical conductivity (e.g., relatively low ionic conductivity). A sufficient amount of solvent preferably is present in the electrolyte composition so that ionic conductivity is increased. A surprisingly low concentration of solvent, e.g., as low as about 5 percent by weight, may be used in polymeric electrolyte compositions to increase ionic conductivity. The concentration of the solvent is preferably about 5 weight percent or more based on the total weight of the polymeric electrolyte compositions. For example, the ionic conductivity of a polymeric electrolyte composition of the present invention which includes about 15 weight percent solvent may be more than 200 times greater than the ionic conductivity of a polymeric electrolyte composition having the identical composition except containing no solvent. Further increases in the ionic conductivity may be obtained by further increasing the solvent concentration. The concentration of the solvent in the electrolyte composition is preferably about 25 weight percent or more, more preferably about 30 weight percent or more, even more preferably about 35 weight percent or more, even more preferably about 45 weight percent or more, and most preferably about 50 weight percent or more. The concentration of the solvent in the electrolyte composition is preferably about 75 weight percent or less, more preferably about 65 weight percent or less, and most preferably about 60 weight percent or less, based on the total weight of the electrolyte.

Additional Characteristics of the Polymeric Electrolyte Composition Conductivity

The polymeric electrolyte compositions herein (e.g., the solid polymeric electrolyte compositions) may have a room temperature conductivity of about 10⁻⁴ S/cm or more, preferably about 3×10⁻³ S/cm or more, and most preferably greater than about 10⁻³ S/cm or more. The conductivity of the polymeric electrolyte compositions may be measured using AC impedance spectroscopy in a Solartron as described herein in the section title “Test Methods”.

As gleaned from the above discussion, the organic particles unexpectedly increases the electrical conductivity (e.g., the ionic conductivity) of the polymeric electrolyte composition. For example, the electrical conductivity (e.g., the ionic conductivity) of a polymeric electrolyte composition including the porous organic particles may be at least 200 percent greater, preferably at least 500 percent greater, more preferably at least 800 percent greater, and most preferably at least 1000 percent greater than the electrical conductivity (e.g., the ionic conductivity) of a comparable electrolyte composition that is free of the porous organic particles and otherwise has the identical composition.

### Mechanical Properties

The polymeric electrolyte composition preferably is ductile at low temperatures. For example, the polymeric electrolyte composition may be ductile at room temperature, preferably at about 0° C., more preferably at about −20° C., and most preferably at about −40° C. Ductility may be quantified by a tensile elongation test at failure of about 10 percent or more, (preferably about 12 percent or more), as measured according to ASTM D882-97 (using sample type ASTM D638-03 IV) at the desired temperature. The tensile elongation test may also be used to measure the elastic modulus, E of the material, according to ASTM D882-97. The polymeric electrolyte compositions may be characterized by a relatively high elastic modulus, e.g., about 20 MPa or more.

Other mechanical properties (e.g., the shear modulus, the loss modulus, and the tan delta) of the polymers and of the polymeric electrolyte compositions may be measured using dynamic mechanical analysis (e.g., according to ASTM D5279-08). Unless otherwise specified, the shear modulus is measured at a temperature of about 30° C. and a oscillatory rate of about 1 radian/sec. The glass transition temperature (T_{g}) of the polymers and of the polymeric electrolyte compositions may also be measured using dynamic mechanical analysis (e.g., according to ASTM E1640-99).

The polymeric electrolyte compositions of the present invention may be characterized by a relatively high modulus (e.g., a relatively high shear modulus). Without limitation, suitable compositions may have a shear modulus of about 10⁴ dynes/cm² (i.e., about 0.001 MPa) or more, preferably about 10⁵ dynes/cm² or more, more preferably about 10⁶ dynes/cm² or more, and most preferably about 10⁷ dynes/cm² or more, as measured by ASTM D5279-08 at a temperature of about 30° C. and about 1 radian/sec.

In the art, it generally has been regarded that the conductivity of a polymeric electrolyte composition is inversely related to the shear modulus of the electrolyte. Thus, efforts to achieve both a high conductivity and a high shear modulus have been generally unsuccessful. For example, efforts to increase conductivity by an increase in the concentration of the solvent typically resulted in an increase in the ionic conductivity but a decrease in the shear modulus of the polymeric electrolyte composition. Contrary to conventional teachings, the polymeric electrolyte compositions of the present invention advantageously may have both a high shear modulus and a high electrical conductivity (e.g., the ionic conductivity). For example the electrolyte compositions may be characterized by a product of the shear modulus, G′ (measured at about 1 radian/sec and about 30° C.), and the conductivity, a (measured at about 30° C. and AC current amplitude of about 10 mV), G′·σ, that may be relatively high. For example, G′·σ preferably is about 10³ (S/cm)(dynes/cm²) (i.e., about 10⁻⁴ (S/cm)(MPa)) or more, more preferably about 3×10³ (S/cm)(dynes/cm²) or more, and most preferably about 10⁴ (S/cm)(dynes/cm²) or more. Such electrolyte compositions preferably may be further characterized by a shear modulus, G′, of about 10⁴ dynes/cm² (i.e., about 10⁻³ MPa) or more, and more preferably about 10⁵ dynes/cm² or more. Such electrolyte compositions preferably may be further characterized by a shear modulus, G′, of about 10¹⁰ dynes/cm² (i.e., about 10³ MPa) or less, and more preferably about 10⁹ dynes/cm² or less.

As another example, the polymeric electrolyte composition (e.g., the solid polymeric electrolyte) may be characterized as having room temperature conductivity of about 10⁴ S/cm or more, preferably about 10⁻³ S/cm or more; and a shear modulus of about 10⁷ dynes/cm² (i.e., about 1 MPa) or more, preferably about 10⁸ dynes/cm² or more.

The compositions herein may be substantially anhydrous, or even entirely anhydrous. Preferably the concentration of water in the composition is about 10 weight percent or less, more preferably about 2 weight percent or less, even more preferably about 1 weight percent or less, even more preferably about 0.1 weight percent or less, and most preferably about 0.01 weight percent or less, based on the total weight of the composition

The structural phase of the polymeric electrolyte composition will distribute itself so as to effectively define a discrete phase or possibly a co-continuous phase. The high mechanical strength of the structural phase may be characterized by a relatively high elastic modulus, a relatively high tensile strength, a relatively high shear modulus, a relatively high degree of crystallinity, a relatively high melting temperature, a relatively high glass transition temperature, or any combination thereof (e.g., in relation with the conductive phase). For example, the structural phase may have either a melting temperature or a glass transition temperature greater than about 50° C., preferably greater than about 60° C., more preferably greater than about 80° C., and most preferably greater than about 100° C. The structural phase may be present at a concentration greater than 5 percent, preferably greater than 12 percent, more preferably greater than 20 percent and most preferably greater than 30 percent, based on the total volume of the polymeric electrolyte composition. The structural phase may be present at a concentration less than 85 percent, preferably less than 75 percent, more preferably less than 65 percent, and most preferably less than 60 percent by volume, based on the total volume of the polymeric electrolyte composition.

The total concentration of the second phase (e.g., including the EOP, solvent and metal salt which may be in that phase) may be greater than 15 percent, preferably greater than 25 percent, more preferably greater than 35 percent, and most preferably greater than 40 percent by volume based on the total volume of the polymeric electrolyte composition. The total conductive phase may be less than 95 percent, preferably less than 90 percent, more preferably less than 85 percent, and most preferably less than 80 percent by volume based on the total volume of the polymeric electrolyte composition.

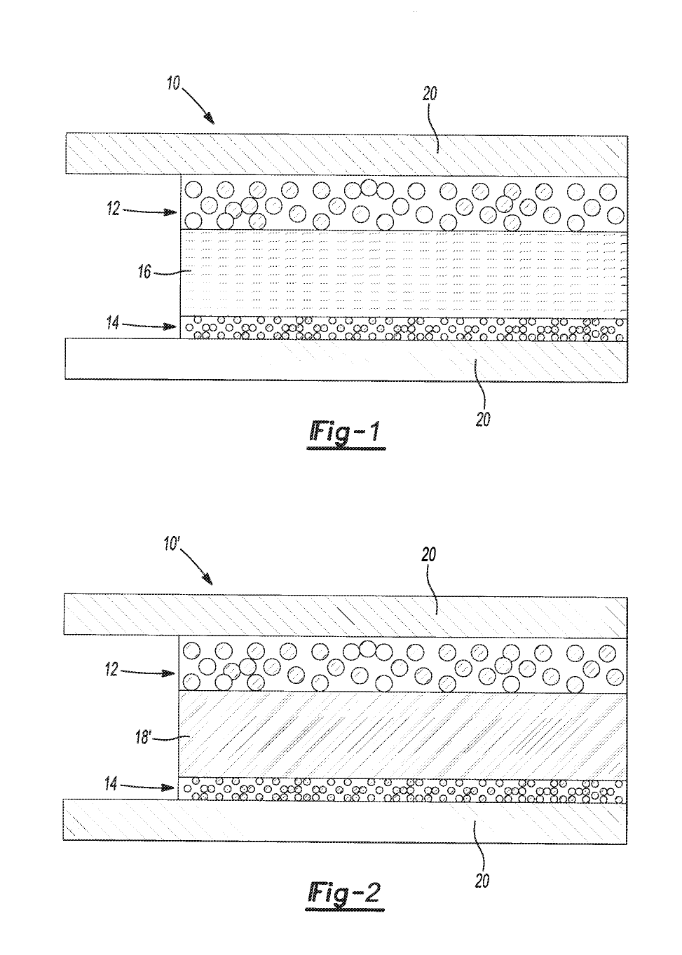

The compositions described herein may be used as an electrolyte in a secondary battery cell including at least one anode, at least one cathode, one or more current collectors, and optionally a separator, all in a suitable housing. As depicted in FIG. 1, an example of a secondary battery cell 10 is shown. It includes an anode 12 and a cathode 14. The anode and the cathode each may be attached to one or more metal current collectors 20. The metal current collectors may be electrically connected to devices and/or circuits requiring electricity (not shown). The secondary battery cell may optionally include a separator 16, such as a porous or semi-porous film. One or more ions in the electrolyte 18, may reversibly move between the anode, the cathode, and the electrolyte during charging and discharging of the battery. The secondary battery cell may be free of a separator, as depicted in FIG. 2. Such a secondary battery 10′ may include an anode 12, a cathode 14, current collectors 20, and a solid polymer electrolyte 18′ (e.g., the polymeric electrolyte composition of the present teachings), located between, and in electrical communication (e.g., in physical contact) with the anode 12, the cathode 14, or both.

A battery may include one or more battery cells. Typically, a plurality of battery cells 10 or 10′ are connected to form a secondary battery. A plurality of cells may be provided by any convenient means. For example, two or more cells may be provided separately and stacked. Advantageously, the secondary battery cells may be provided as a continuous sheet or film which may be folded (e.g., fan folded), rolled, or otherwise stacked to form a high packing density of cells. Folded or stacked cells may be arranged such that the cells are in a parallel arrangement. When rolled, the cells may be in a concentric, or nearly concentric arrangement.

The polymeric electrolyte compositions described herein may be used in a battery (e.g., an anhydrous secondary battery, such as a lithium battery, or in an aqueous battery, such as a Ni-metal hydride, a zinc/air, a lithium/air or carbon/zinc battery), a fuel cell (e.g., a cell in which the conductor is protons), a photovoltaic cell (e.g., a Graetzel cell), electrochemical devices, and sensor devices. The polymeric electrolyte compositions may be used for energy storage devices (e.g., batteries), and particularly in applications such as transportation which require light weight energy storage devices. In particular, the polymeric electrolyte compositions of the present invention may be used in secondary batteries, such as batteries which may be recharged (e.g., recharged about 10 or more times, about 100 or more times, or even about 1000 or more times) with less than about 25 percent (or even less than about 10 percent) loss in storage energy.

The polymeric electrolyte compositions disclosed herein may be used in a battery for providing power to an electrical device. Without limitation, the polymeric electrolyte compositions may be advantageously used in a battery for providing power to a mobile device, such as a cell phone, a vehicle (e.g., a vehicle having an electric engine), a portable device for recording or playing sound or images (e.g., a camera, a video camera, a portable music or video player such as a compact disk, cassette tape or MP3 playing device, a portable DVD player, a digital book or other wireless reading device such as a Kindle®), a portable computer and the like. Thus, such devices (e.g., mobile devices) including a battery containing a polymeric electrolyte composition disclosed herein are within the teachings herein.

The invention also contemplates electrolyte precursors, such as the electrolyte minus the metal salt. Thus, such compositions without the salt are with the teachings herein.

### Composite Electrode

The compositions herein may also be used for a composite electrode, (e.g., a composite anode) which includes one or more electroactive particles, “EAPs”, dispersed in the polymeric electrolyte compositions. Preferred composite electrodes include from about 20 weight percent to about 80 weight percent EAPs, based on the total weight of the electrode. The composite electrode preferably includes the polymeric electrolyte composition at a concentration from about 20 weight percent to about 80 weight percent based on the total weight of the composite electrode.

The electroactive particles may be any size or shape so that a composite electrode can be formed. The electroactive particles preferably have a particle size (e.g., a median diameter, a mean diameter, a median length, a mean length, a top particle diameter, a top particle length, or any combination thereof) of about 100 μm or less, more preferably about 10 μm or less, even more preferably about 3 μm or less, and most preferably about 1 μm or less. The electroactive particles preferably have a particle size (e.g., a median diameter, a mean diameter, a median length, a mean length, a top particle diameter, a top particle length, or any combination thereof) of about 0.01 μm or more, more preferably about 0.05 μm or more.

The electroactive particles may have overlapping conduction bands and valence bands. For example, the electroactive particle may include a metal, a metal alloy, a metal oxide, or any combination thereof. The electroactive particle may include V, Fe, Mn, Co, Ni, Ti, Zr, Ru, Re, Pt, Li, or any combination thereof. Preferably the EAP includes an oxide containing one, two, three, four, or more metals. Without limitation, exemplary EAPs, may include lithium. For example, the EAP may include Li, O, and another metal selected from Ni, Co, Mn, Ti, or any combination thereof. The plurality of electroactive particles may include a plurality of particles of a single chemical structure (e.g., a single metal, a single metal alloy, or a single metal oxide) or may include particles having different chemical structures (e.g., two or more different lithium containing particles). Uncoated or coated particles may be used in the composite electrode. Preferred EAPs are uncoated particles.

### Process For Preparing Electrolyte

The EOP and the organic particles (e.g. porous organic microparticles) may be combined by any convenient means to blend or mix the materials such that organic particles are dispersed in the EOP. In the case of hollow, porous particles, the EOP may penetrate and fill at least some (preferably most, or even all) of the voids in the particles. In the case of hollow, non-porous particles, the EOP typically will not penetrate the solid shell, and thus typically not fill the voids in the particles. The mixing is preferably at a relatively low temperature such that the organic particles do not substantially melt, soften, or flow. For example the mixing temperature may be less than (e.g., at least 10° C. less than, preferably at least 20° C. less than, more preferably at least 25° C. less than, and most preferably at least 35° C. less than) the softening temperature (i.e., the melting temperature of a semi-crystalline polymer, or the glass transition temperature of a glassy polymer) of the organic particles. The mixing is preferably done under a condition in which the EOP flows. For example the mixing temperature may be greater than the melting temperature of the EOP, the EOP may be solvated, or both. Without limitation, the EOP may be added as an aqueous solution. In another example, the EOP may be added as a solid to a latex containing the organic particles, such that the EOP forms a solution with the water in the latex (e.g., the porous organic particles may be provided as a latex, such as a latex including at least about 20 weight percent porous organic particles and at least about 20 weight percent water). If water is used in the mixing step, the process preferably contains one or more drying steps to remove at least 90 percent, preferably at least 99 percent (e.g., substantially entirely all) of the water.

The microparticles may be added as a dispersion, such as a dispersion including at least 20 weight percent particles and at least 20 weight percent solvent (e.g., carbonate solvent).

The metal salt and optional solvent may be added when the particles and EOP are combined, or they may be added in a subsequent step. If water is used in preparing the mixture, the material is preferably dried prior to adding the solvent.

The electrolyte compositions may be formed into a sheet, film or other structure so that it may be used in an electrochemical cell. Any suitable process may be employed to form the electrolyte composition, such as an extrusion process, a coating process, a molding process, and the like. Preferred processes include a step of heating the composition to a maximum temperature at which the EOP polymer is a liquid, at which at least one polymer of the organic particles is a solid, or both. The process may optionally include one or more drying steps. Preferably the electrolyte composition is formed into a film having a thickness of about 2 mm or less, more preferably about 1 mm or less, even more preferably about 0.5 mm or less, even more preferably about 0.2 mm or less, and most preferably about 0.1 mm or less. Preferably the electrolyte composition is formed into a film having a thickness of about 0.2 μm or more, more preferably about 1 μm or more, and most preferably about 10 μm or more.

### Test Methods

Unless otherwise specified, melting temperature refers to the peak melting temperature. The melting temperature (i.e., peak melting temperature, Tₚ), final melting temperature (T_{f}), and heat of fusion (H_{f}) may be measured using differential scanning calorimetry. A 1-3 mg sample of the material is heated to about 150° C. and then cooled to −20° C. at a rate of about −10° C./min. The second heating is at a rate 10° C./min to abut 150° C. The peak melting temperature, melting temperature and heat of fusion are measured on the second heating. The crystallinity, Xc, is calculated by dividing H_{f} by the heat of the theoretical heat of fusion, Hₜ, for the polymer (i.e., the polyethylene oxide homopolymer) having 100 percent crystallinity, and multiplying by 100 percent:

Xc=100 percent×(H_{f}/Hₜ)

where Hₜ, =188 J/g and the theoretical T_{f} for a perfect crystal is 66° C. for polyethylene oxide homopolymer, Hₜ, =287 J/g for polyethylene (see e.g., F. Rodriguez, Principles of Polymer Science, 2^{nd} Edition, Hemisphere Publishing Co., 1982, p. 54), and Hₜ, =165 J/g for isotactic polypropylene (see e.g., B. Wunderlich, Macromolecular Physics, Volume 3, Crystal Melting, Academic Press, New York, 1980, p. 48).

The conductivity of the polymeric electrolyte compositions may be measured using AC impedance spectroscopy in a Solartron using an alternating current (AC) amplitude of about 10 mV. Details of the AC impedance spectroscopy method are in Handbook of Batteries, 3rd Ed; David Linden and Thomas Reddy, Editors, McGraw-Hill, 2001, New York, N.Y., pp. 2.26-2.29, incorporated herein by reference.

The shear modulus, the loss modulus, and the tan delta of the polymers and of the polymeric electrolyte compositions may be measured using dynamic mechanical analysis (e.g., according to ASTM D5279-08). Unless otherwise specified shear modulus is measured at a temperature of about 30° C. and a shear rate of about 1 radian/sec at a strain of typically about 0.04 percent.

Dynamic mechanical analysis of samples that are free of solvent is performed a Rheometrics Ares using torsion on a rectangular geometry. Data collection and analysis is handled by TA Orchestrator V 6.6. OB2 software package. The geometry of the samples is about 25-30 mm×about 6-13 mm×about 1.6 mm. The temperature sweep experiments are carried out at 2° C./min from −100° C. to 50-100° C. A frequency of 1 rad/s is used.

Dynamic mechanical analysis of samples that contain solvent at a concentration less than 40 weight percent is performed on a Rheometrics Solid Analyzer RSA II using 15 mm parallel plates geometry. Data collection and analysis is handled by RSI Orchestrator V6.5.8 software package. The samples are prepared by compression molding at room temperature with a pressure of 5-8 tons. The diameter and thickness of the samples are about 12.7 mm and about 1.8 mm, respectively.

Dynamic mechanical analysis of samples that contain more than 40 weight percent solvent are performed on a Paar Physica UDS-200 rheometer using a 25 mm, 6° cone fixture and plate geometry. Data collection and analysis is handled by the Paar Physica US200 ver. 2.21 software package. The sample is placed in the center on the bottom plate. The test fixture is then lowered to a height of 0.06 mm by the instrument. Once that height is obtained, the software stops the fixture and notifies that the excess material should be cleaned from the test fixtures. After cleaning, the fixture is lowered to the appropriate test height, 0.05 mm.

The glass transition temperature (T_{g}) of the polymers and of the electrolyte compositions may also be measured using dynamic mechanical analysis (e.g., according to ASTM E1640-99), using the test equipment, conditions, and sample geometry described above

### Void Fraction

The volume of the voids in the hollow, non-porous microparticles and the hollow porous microparticles may be characterized by the average void fraction (i.e., average wet void fraction). The wet void fraction may be measured using the method described by Keefe et. al (PCT Patent Application Publication No. WO2008/067444A1, published Jun. 5, 2008, page 12, lines 9 through 27), incorporated herein by reference. The wet void fraction is determined using the following procedure. To a 50 ml polypropylene centrifuge tube (with a hemispherical bottom) is added 40 grams of the hollow microparticles in water (e.g., latex). The tube is placed in a centrifuge and spun at 19,500 rpm for 180 minutes. The supernatant is decanted and weighed. From the latex mass, percent solids, and supernatant mass, the wet void fraction (f_{void}) is determined using the following equation:

f_{void}=[(V_{T}−S_{H2O})×F_{R}−Vₚ]/[(V_{T}−S_{H2O})×F_{R}]

where

Vₚ=polymer volume of the latex particles (i.e., polymer mass/polymer density) where the density of copolymers is calculated using literature values for the density of the homopolymers of each monomer, and assuming that the density of the copolymer is a linear function of the compositions of the copolymer. See Peter A. Lovell and Mohamed S. El-Aasser, “Emulsion Polymerization and Emulsion Polymers”, p. 624, John Wiley and Sons: New York (1977).

V_{T}=Total volume in the tube (mass of latex/density of latex)

S_{H20}=Volume of supernatant=weight of supernatant

F_{R}=packing factor which equals 0.64 for random packing of essentially monodisperse sphere. The packing factor is a correction corresponding to the volume fraction of the solids in the hard pack.

### EXAMPLES

### Materials

PEO-1: A polyethylene oxide homopolymer having a weight average molecular weight, Mw, of about 100,000 Da.

PS-L-1: A latex including about 50 weight percent polystyrene copolymer microparticles and about 50 weight percent water. PS-L-1 has a melting temperature of about 110.6° C., a heat of fusion of about 46.83 J/g and a glass transition temperature of about −27.83° C. PS-L-1 is a developmental material prepared by The Dow Chemical Company under the designation Dow 31352.00. PS-L-1 was commercially available from DOW CHEMICAL COMPANY under the grade name HS 3000. PS-L-1 contains porous, hollow spherical particles of the polymer having an average particle size of 1 μm.

PS-L-2: A latex including about 50 weight percent polystyrene copolymer microparticles and about 50 weight percent water. The polystyrene copolymer contains about 98.18 weight percent styrene, about 1.73 weight percent acrylic acid, and about 0.10 weight percent butadiene monomer. PS-L-2 has a melting temperature of about 114.0° C., a heat of fusion of about 168.8 J/g and a glass transition temperature of about −39.79° C. PS-L-2 is a developmental material prepared by The Dow Chemical Company under the designation Dow 31352.50. PS-L-2 is commercially available from DOW CHEMICAL COMPANY under the grade name HS 3020. PS-L-2 contains porous, hollow spherical particles of the polymer having an average particle size of 1 μm. The shell of the PS-L-2 particles have fewer and smaller pores than the shells of the PS-L-1 particles.

PS-L-3: A latex containing about 50 weight percent solid microparticles and about 50 weight percent water. The microparticles in PS-L-3 are solid core-shell particles with a polystyrene shell. The PS-L-3 particles are prepared according to the method described by Kowalski et. a., U.S. Pat. No. 4,427,836 issued Jan. 24, 1984, incorporated herein in its entirety by reference.

PS-L-4: A latex containing about 50 weight percent hollow, non-porous microparticles and about 50 weight percent water.

Lithium triflate (i.e., lithium trifluoromethanesulfonate having the chemical formula CF₃LiO₃S, and CAS Number 33454-82-9) and having a molecular weight of about 156 Daltons.

### Example 1

43.6 weight percent PS-L-1, 43.6 weight percent PEO-1, and 12.8 weight percent lithium triflate are combined in a beaker with enough deionized water to dissolve the PEO. The mixture is mixed overnight at a temperature of about 25° C. The mixing temperature is kept below the glass transition temperature of the polymer in the PS-L-1 latex. Mixing is continued until the PEO-1 is dissolved and the solution is homogeneous. The solution is then dried at room temperature using a continuous flow of nitrogen gas to remove the water. The drying is completed under vacuum at room temperature to remove the remaining water. After drying, the composition contains a molar ratio of ethylene oxide groups (EO) on the polyethylene oxide to lithium (i.e., on the lithium triflate) of about 12:1.

### Examples 2-6

Examples 2, 3, 4, 5, and 6 are prepared using a similar procedure as in Example 1 using the concentration given in TABLE 2. The concentration of the lithium triflate is chosen so that the molar ratio of oxygen (i.e., ethylene oxide) to lithium (i.e., lithium triflate) is about 12:1. Example 2, and Example 3 are prepared with a weight ratio of PS-L-1:PEO-1 of about 2:1 and about 3:1, respectively. Examples 4, 5 and 6 are prepared using PS-L-2 instead of PS-L-1. Example 4, Example 5, and Example 6 are prepared with a weight ratio of PS-L-2:PEO-1 of about 1:1. about 2:1 and about 3:1, respectively.

Comparative Example 7 is prepared by mixing PEO-1 and lithium triflate at a temperature above the melting temperature of the PEO-1 as shown in TABLE 2.

Examples including propylene carbonate solvent are prepared by dissolving the PEO in deionized water to form a PEO solution and mixing the PEO solution with the latex (which contains about 50 percent polymer and about 50 percent water) Ratios of latex to PEO of 1:1, 2:1, and 3:1 are used. The materials are mixed by stirring at about 20° C. for about 24 hours. The lithium triflate salt is then added at an amount to give an O:Li ratio of about 12:1. The total weight of the mixture is about 25 g. The mixture is mixed for about 24 hours and then placed on a crystallization dish under a flow of dry nitrogen gas and dried for up to 7 days. The material is then vacuum dried for 1 day. The dried composition is then placed in vials and propylene carbonate solvent is added to the vials to give compositions having propylene carbonate concentrations of 15 percent, 30 percent, 45 percent. 60 percent, 75 percent, and 90 percent. The vials are sealed and placed on a shaker until the samples are a homogeneous material (e.g., a gel).

### Results

The conductivity is measured using AC impedance spectroscopy in a Solartron using an AC amplitude of about 10 mV. Details of the AC impedance spectroscopy method are in Handbook of Batteries, 3rd Ed; David Linden and Thomas Reddy, Editors, McGraw-Hill, 2001, New York, N.Y., pp. 2.26-2.29, incorporated herein by reference. Mechanical properties (shear modulus and loss modulus) are measured by dynamic mechanical spectroscopy (e.g., according to ASTM D5279-08) at a temperature of about 30° C. and a shear rate of about 1 radian/sec. The glass transition temperature of the PEO phase is measured using dynamic mechanical analysis (e.g., according to ASTM E1640-99) and the crystallinity of the PEO phase is measured using differential scanning calorimetry.

Thus formed, the SPE samples are tested using dynamic mechanical analysis (e.g., according to ASTM E1640-99) to measure the glass transition temperature (T_{g}). Samples are prepared for electrical and mechanical measurements. Conductivity is measured using AC impedance spectroscopy in a Solartron. Mechanical properties (shear modulus and loss modulus) are measured by dynamic mechanical spectroscopy (e.g., according to ASTM D5279-08).

Surprisingly the addition of the latex to the PEO generally increases both the conductivity and the shear modulus.

As illustrated in Table 2, below, the electrical conductivity (e.g., the ionic conductivity) of the electrolyte composition containing the organic microparticles (e.g., PS nanobeads) and EOP (e.g., PEO homopolymer) may be higher than the EOP (e.g., PEO homopolymer) compositions that do not include the organic microparticles.

Surprisingly the crystallinity of the PEO decreases significantly with the addition of the PS particles. At a concentration of about 27.9 weight percent PS particles (and about 55.7 weight percent PEO-1), the crystallinity of the PEO decreases to less than about 58 percent. In comparison, Comparative Example 7, which is free of the PS particles and contains about 77.2 weight percent PEO, has a crystallinity of about 70 percent.

TABLE 2

| | Example | | | | | | |
|---|---|---|---|---|---|---|---|
| | 1 | 2 | 3 | 4 | 5 | 6 | 7 |
| Wet PS-L:PEO-1 | 1:1 | 2:1 | 3:1 | 1:1 | 2:1 | 3:1 | 0 |
| weight ratio | | | | | | | |
| Dry PS:PEO-1 weight | 1:2 | 1:1 | 3:2 | 1:2 | 1:1 | 3:2 | 0 |
| ratio | | | | | | | |
| EO:Lithium triflate mole | 12:1 | 12:1 | 12:1 | 12:1 | 12:1 | 12:1 | 12:1 |
| ratio | | | | | | | |
| EO:Lithium triflate | 3.39:1 | 3.39:1 | 3.39:1 | 3.39:1 | 3.39:1 | 3.39:1 | 3.39:1 |
| weight ratio | | | | | | | |

Concentration (in weight percent) before drying

| | | | | | | | |
|---|---|---|---|---|---|---|---|
| PS-L-1, % | 43.6 | 60.7 | 69.8 | | | | |
| PS-L-2, % | | | | 43.6 | 60.7 | 69.8 | |
| PEO-1, % | 43.6 | 30.3 | 23.3 | 43.6 | 30.3 | 23.3 | 77.2 |
| Lithium Triflate, % | 12.9 | 9.0 | 6.9 | 12.9 | 9.0 | 6.9 | 22.8 |
| Total, % | 100.0 | 100.0 | 100.0 | 100.0 | 100.0 | 100.0 | 100.0 |

Concentration in weight percent) after drying

| | | | | | | | |
|---|---|---|---|---|---|---|---|
| PS-L-1 (polymer), % | 27.9 | 43.6 | 53.6 | | | | |
| PS-L-2 (polymer), % | | | | 27.9 | 43.6 | 53.6 | |
| PEO-1, % | 55.7 | 43.6 | 35.8 | 55.7 | 43.6 | 35.8 | 77.2 |
| Lithium Triflate, % | 16.4 | 12.9 | 10.6 | 16.4 | 12.9 | 10.6 | 22.8 |
| Total | 100.0 | 100.0 | 100.0 | 100.0 | 100.0 | 100.0 | 100.0 |
| Heat of fusion of | 40.88 | 50.87 | 73.42 | 43.06 | 50.87 | 73.42 | |
| particle phase, J/g | | | | | | | |
| Peak Melting | 139.98 | 117.31 | 114.07 | 146.62 | 127.99 | 125.79 | |
| temperature of particle | | | | | | | |
| phase, ° C. | | | | | | | |
| Heat of fusion of PEO | 58.78 | 37.06 | 32.3 | 56.4 | 37.42 | 34.61 | 101 |
| phase, J/g | | | | | | | |
| Peak Melting | 53.35 | 53.63 | 51.29 | 56.58 | 55.11 | 53.85 | 63.97 |
| temperature of PEO | | | | | | | |
| phase, ° C. | | | | | | | |
| Crystallinity of PEO | 56 | 45 | 48 | 54 | 46 | 51 | 70 |
| phase, percent of PEO | | | | | | | |
| G′ @30° C. (dynes/cm²) | 4.5E+09 | 3.1E+09 | 1.3E+09 | 3.6E+09 | 3.1E+09 | 3.7E+09 | 1.76E+9 |
| σ @30° C. (S/cm) | 5.5E−07 | 3.7E−07 | 4.5E−07 | 3.8E−07 | 2.4E−07 | 2.6E−07 | 2.42E−08 |
| G′ × σ, S/cm) | 2474 | 1147 | 585 | 1368 | 744 | 962 | 43 |
| (dynes/cm²) | | | | | | | |

Tables 3A and 3B illustrate compositions and properties of comparative electrolyte samples including the polyethylene oxide homopolymer and the lithium triflate at a ratio of about 12, and 0 percent, 15 percent, 30 percent, 45 percent, 60 percent, 75 percent, and 90 percent p(by weight) propylene carbonate solvent. The product of the shear stress and the ionic conductivity (both measured at about 30° C.) ranges from less than about 0.02 to about 42.7 (S/cm)(dynes/cm²).

TABLE 3A
Formulations and Properties of Electrolytes Compositions Including
a PEO Homopolymer and Lithium Triflate with No Microparticles.

| | Comparative Example | | | |
|---|---|---|---|---|
| | 8 | 9 | 10 | 11 |
| Propylene carbonate, | 0 | 15 | 30 | 45 |
| weight percent | | | | |
| Polyethylene oxide + | 100 | 85 | 70 | 55 |
| lithium triflate, wt. % | | | | |
| Microparticles, weight | 0 | 0 | 0 | 0 |
| percent | | | | |
| O:Li molar ratio | 12:1 | 12:1 | 12:1 | 12:1 |
| G′ @30° C. (dynes/cm²) | 1.76E+09 | 1.27E+05 | 6.60E+03 | 2.34E+03 |
| σ @30° C. (S/cm) | 2.42E−08 | 5.46E−05 | 3.02E−04 | 9.50E−04 |
| σ @60° C. (S/cm) | 1.91E−06 | 1.51E−04 | 7.75E−04 | 1.76E−03 |
| G′ × σ @30° C., | 42.7 | 6.9 | 2.0 | 2.2 |
| (S/cm) (dynes/cm²) | | | | |

TABLE 3B
Formulations and Properties of Electrolytes Compositions Including
a Homopolymer PEO and Lithium Triflate with No Microparticles

| | Comparative Example | | |
|---|---|---|---|
| | 12 | 13 | 14 |
| Propylene carbonate, weight percent | 60 | 75 | 90 |
| Polyethylene oxide + lithium | 40 | 25 | 10 |
| triflate, wt. % | | | |
| Microparticles, weight percent | 0 | 0 | 0 |
| O:Li molar ratio | 12:1 | 12:1 | 12:1 |
| G′ @30° C. (dynes/cm²) | 8.45E+02 | 9.04E+00 | |
| σ @30° C. (S/cm) | 1.61E−03 | 1.84E−03 | 8.21E−04 |
| σ @60° C. (S/cm) | 2.70E−03 | 2.74E−03 | 1.08E−03 |
| G′ × σ @30° C., (S/cm) (dynes/cm²) | 1.4 | 0.02 | |

Tables 4A and 4B illustrate compositions and properties of electrolyte samples including the polyethylene oxide homopolymer and the lithium triflate at a ratio of about 12. These electrolyte samples also include porous, hollow microparticles (from latex L-PS-1). The samples in Table 4A are prepared from EX.1 by adding propylene carbonate solvent at 15 percent, 30 percent, 45 percent, 60 percent, and 75 percent. The samples in Table 4B are prepared from EX. 3 by adding propylene carbonate solvent at 30 percent, 45 percent, 60 percent, 75 percent and 90 percent by weight. The product of the shear stress and the ionic conductivity (both measured at about 30° C.) ranges from less than about 1400 to about 51000 (S/cm)(dynes/cm²).

TABLE 4A
Formulations and Properties of Electrolytes Compositions Including a PEO
Homopolymer and Lithium Triflate with porous, hollow L-PS-1 Microparticles.
Formulation based on dry weight of latex polymer

| | Example | | | | |
|---|---|---|---|---|---|
| | 15 | 16 | 17 | 18 | 19 |
| Propylene carbonate, weight % | 15.0 | 30.0 | 45.0 | 60.0 | 75.0 |
| Polyethylene oxide + lithium | 61.4 | 50.5 | 39.7 | 28.9 | 18.1 |
| triflate, weight percent | | | | | |
| Porous, hollow polystyrene | 23.6 | 19.5 | 15.3 | 11.1 | 7.0 |
| microparticles (L-PS-1), weight % | | | | | |
| O:Li molar ratio | 12:1 | 12:1 | 12:1 | 12:1 | 12:1 |
| G′ @30° C. (dynes/cm²) | 6.2E+07 | 1.1E+08 | 5.2E+07 | 7.9E+06 | 2.8E+06 |
| σ @30° C. (S/cm) | 4.1E−05 | 1.7E−04 | 2.1E−04 | 1.8E−04 | 7.5E−04 |
| σ @60° C. (S/cm) | 2.3E−04 | 5.7E−04 | 9.5E−04 | 9.4E−04 | 1.7E−03 |
| G′ × σ @30° C., (S/cm) (dynes/cm²) | 2496 | 19520 | 10950 | 1446 | 2065 |

TABLE 4B
Formulations and Properties of Electrolytes Compositions Including a PEO
Homopolymer and Lithium Triflate with porous, hollow L-PS-1 Microparticles.
Formulation based on dry weight of latex polymer

| | Example | | | | |
|---|---|---|---|---|---|
| | 20 | 21 | 22 | 23 | 24 |
| Propylene carbonate, weight % | 30.00 | 45 | 60.00 | 75 | 75 |
| Polyethylene oxide + lithium triflate, | 32.5 | 25.5 | 18.6 | 11.6 | 4.6 |
| weight percent | | | | | |
| Porous, hollow polystyrene | 37.5 | 29.5 | 21.4 | 13.4 | 5.4 |
| microparticles (L-PS-1), weight % | | | | | |
| O:Li molar ratio | 12:1 | 12:1 | 12:1 | 12:1 | 12:1 |
| G′ @30° C. (dynes/cm²) | 2.65E+08 | 5.26E+07 | 1.89E+07 | 4.4E+07 | 2.89E+7 |
| σ @30° C. (S/cm) | 1.6E−04 | 1.5E−04 | 8.7E−04 | 1.2E−03 | 1.1E−03 |
| σ @60° C. (S/cm) | 6.4E−04 | 1.1E−03 | 1.6E−03 | 2.0E−03 | 1.9E−03 |
| G′ × σ @30° C., (S/cm) (dynes/cm²) | 42442 | 7943 | 16500 | 51325 | 33062 |

Tables 5A and 5B illustrate compositions and properties of electrolyte samples including the polyethylene oxide homopolymer and the lithium triflate at a O:Li ratio of about 12. These electrolyte samples also include porous microparticles (from latex L-PS-2). The samples in Table 5A are prepared from EX.4 by adding propylene carbonate solvent at 15 weight percent, 30 weight percent, 45 weight percent, and 60 weight percent. The samples in Table 5B are prepared from EX. 6 by adding propylene carbonate solvent at 15 percent, 45 percent, and 75 percent by weight. The product of the shear stress and the ionic conductivity (both measured at about 30° C.) ranges from less than about 1400 to about 28000 (S/cm)(dynes/cm²).

TABLE 5A
Formulations and Properties of Electrolytes Compositions
Including a PEO Homopolymer and Lithium Triflate with
Porous, Hollow L-PS-2 Microparticles.
Formulation based on dry weight of latex polymer

| | Example | | | |
|---|---|---|---|---|
| | 25 | 26 | 27 | 28 |
| Propylene carbonate, | 15.0 | 30.0 | 45.0 | 60.0 |
| weight percent | | | | |
| Polyethylene oxide + | 61.4 | 50.5 | 39.7 | 28.9 |
| lithium triflate, weight % | | | | |
| Porous, hollow | 23.6 | 19.5 | 15.3 | 11.1 |
| polystyrene | | | | |
| microparticles (L-PS-2), | | | | |
| weight percent | | | | |
| O:Li molar ratio | 12:1 | 12:1 | 12:1 | 12:1 |
| G′ @30° C. (dynes/cm²) | 4.2E+08 | 1.2E+08 | 1.3E+07 | 6.8E+06 |
| σ @30° C. (S/cm) | 3.9E−05 | 1.3E−04 | 3.9E−04 | 4.7E−04 |
| σ @60° C. (S/cm) | 2.4E−04 | 6.5E−04 | 1.3E−03 | 1.5E−03 |
| G′ × σ @30° C. | 16479 | 15730 | 5007 | 3187 |

TABLE 5B
Formulations and Properties of Electrolytes Compositions
Including a PEO Homopolymer and Lithium Triflate with
Porous, Hollow L-PS-2 Microparticles.
Formulation based on dry weight of latex polymer

| | Example | | |
|---|---|---|---|
| | 29 | 30 | 31 |
| Propylene carbonate, weight percent | 15.0 | 45.0 | 75.0 |
| Polyethylene oxide + lithium | 39.4 | 25.5 | 11.6 |
| triflate, weight percent | | | |
| Porous, hollow polystyrene | 45.6 | 29.5 | 13.4 |
| microparticles (L-PS-2), wt. % | | | |
| O:Li molar ratio | 12:1 | 12:1 | 12:1 |
| G′ @30° C. (dynes/cm²) | 5.6E+08 | 8.0E+07 | 5.6E+06 |
| σ @30° C. (S/cm) | 2.6E−06 | 3.4E−04 | 1.1E−03 |
| σ @60° C. (S/cm) | 3.0E−05 | 1.3E−03 | 2.1E−03 |
| G′ × σ @30° C., (S/cm) (dynes/cm²) | 1449 | 26851 | 6298 |

Tables 6A and 6B illustrate compositions and properties of electrolyte samples including the polyethylene oxide homopolymer and the lithium triflate at a O:Li ratio of about 12; These electrolyte samples include hollow microparticles (from latex L-PS-4) at dry weights from about 27.8 weight percent to about 2.8 weight percent, and 0 percent, 15 percent, 30 percent, 45 percent, 60 percent, 75 percent, and 90 percent propylene carbonate solvent (by weight). The product of the shear stress and the ionic conductivity (both measured at about 30° C.) ranges from less than about 150 to about 13000 (S/cm)(dynes/cm²).

TABLE 6A
Formulations and Properties of Electrolytes Compositions
Including a PEO Homopolymer and Lithium Triflate with
hollow, non-porous L-PS-4 Microparticles.

| | Example | | | |
|---|---|---|---|---|
| | 32 | 33 | 34 | 35 |
| Propylene | 0.0 | 15.0 | 30.0 | 45.0 |
| carbonate, | | | | |
| weight percent | | | | |
| Polyethylene | 72.2 | 61.4 | 50.5 | 39.7 |
| oxide + lithium | | | | |
| triflate, | | | | |
| weight % | | | | |
| Hollow | 27.8 | 23.6 | 19.5 | 15.3 |
| polystyrene | | | | |
| particles | | | | |
| (L-PS-4), | | | | |
| weight % | | | | |
| O:Li molar | 12:1 | 12:1 | 12:1 | 12:1 |
| ratio | | | | |
| G′ @30° C. | 2.98E+09 | 2.72E+08 | 8.30E+07 | 1.89E+06 |
| (dynes/cm²) | | | | |
| σ @30° C. | 1.0E−07 | 9.4E−05 | 2.1E−04 | 3.5E−04 |
| (S/cm) | | | | |
| σ @60° C. | 2.0E−05 | 4.0E−04 | 6.5E−04 | 9.3E−04 |
| (S/cm) | | | | |
| G′ × σ | 300 | 25646 | 17087 | 670 |
| @30° C., | | | | |
| (S/cm) | | | | |
| (dynes/cm²) | | | | |

TABLE 6B
Formulations and Properties of Electrolytes Compositions
Including a PEO Homopolymer and Lithium Trifiate with
Hollow, Non-Porous Microparticles (L-PS-4)

| | Example | | |
|---|---|---|---|
| | 36 | 37 | 38 |
| Propylene carbonate, weight | 60.0 | 75.0 | 90.0 |
| percent | | | |
| Polyethylene oxide + | 28.9 | 18.1 | 7.2 |
| lithium triflate, weight percent | | | |
| Hollow polystyrene particles | 11.1 | 7.0 | 2.8 |
| (L-PS-4), weight percent | | | |
| O:Li molar ratio | 12:1 | 12:1 | 12:1 |
| G′ @30° C. (dynes/cm²) | 4.25E+05 | 2.66E+05 | 5.08E+05 |
| σ @30° C. (S/cm) | 6.4E−04 | 8.3E−04 | 1.1E−03 |
| σ @60° C. (S/cm) | 1.3E−03 | 1.7E−03 | 2.1E−03 |
| G′ × σ @30° C., (S/cm) | 273 | 220 | 566 |
| (dynes/cm²) | | | |

Tables 7A and 7B illustrate compositions and properties of electrolyte samples including the polyethylene oxide homopolymer and the lithium triflate at a O:Li ratio of about 12; These electrolyte samples include solid core-shell microparticles (from latex L-PS-3) at dry weights from about 27.8 percent to about 2.8 weight percent, and 0 percent, 15 percent, 30 percent, 45 percent, 60 percent, 75 percent, and 90 percent propylene carbonate solvent (by weight). The product of the shear stress and the ionic conductivity (both measured at about 30° C.) ranges from less than about 14 to about 800 (S/cm)(dynes/cm²).

Electrolytes including the hollow, porous microparticles or the hollow, non-porous microparticles and containing less than 60 weight percent solvent may be characterized by a product of the shear modulus and the ionic conductivity, G′×σ, both measured at 30° C., that is at least 1.5 times, preferably at least 2 times, more preferably at least 4 times, and most preferably at least 10 times the value for a comparable electrolyte compositions having the identical composition except using solid particles instead of the porous or hollow particles (e.g., having the same concentrations of solvent, salt, EOP, and particles).

TABLE 7A
Formulations and Properties of Electrolytes Compositions
Including a PEO Homopolymer and Lithium Triflate with
Solid Core-Shell Microparticles (L-PS-3)

| | Example | | | |
|---|---|---|---|---|
| | 39 | 40 | 41 | 42 |
| Propylene | 0.0 | 15.0 | 30.0 | 45.0 |
| carbonate, | | | | |
| weight percent | | | | |
| Polyethylene | 72.2 | 61.4 | 50.5 | 39.7 |
| oxide + | | | | |
| lithium triflate, | | | | |
| weight % | | | | |
| Solid | 27.8 | 23.6 | 19.5 | 15.3 |
| microparticles | | | | |
| (L-PS-3), | | | | |
| weight % | | | | |
| O:Li molar | 12:1 | 12:1 | 12:1 | 12:1 |
| ratio | | | | |
| G′ @30° C. | 1.44E+08 | 6.15E+06 | 3.97E+06 | 2.00E+06 |
| (dynes/cm²) | | | | |
| σ @30° C. | 9.6E−08 | 5.9E−06 | 3.1E−05 | 1.3E−04 |
| (S/cm) | | | | |
| σ @60° C. | 1.8E−06 | 2.7E−05 | 1.2E−04 | 3.9E−04 |
| (S/cm) | | | | |
| G′ × σ | 14 | 36 | 125 | 266 |
| @30° C. | | | | |

TABLE 7B
Formulations and Properties of Electrolytes Compositions
Including a Homopolymer PEO and Lithium Triflate with
Solid Core-Shell Microparticles (L-PS-3)

| | Example | | |
|---|---|---|---|
| | 43 | 44 | 45 |
| Propylene carbonate, weight | 60.0 | 75.0 | 90.0 |
| percent | | | |
| Polyethylene oxide + | 28.9 | 18.1 | 7.2 |
| lithium triflate, weight | | | |
| percent | | | |
| Solid microparticles (L-PS-3), | 11.1 | 7.0 | 2.8 |
| weight percent | | | |
| O:Li molar ratio | 12:1 | 12:1 | 12:1 |
| G′ @30° C. (dynes/cm²) | 1.22E+06 | 2.62E+05 | 5.44E+05 |
| σ @30° C. (S/cm) | 5.5E−04 | 6.3E−04 | 1.5E−03 |
| σ @60° C. (S/cm) | 1.1E−03 | 1.2E−03 | 2.4E−03 |
| G′ × σ @30° C. | 675 | 165 | 796 |

1. A polymeric electrolyte composition comprising
a. a first phase including an organic microparticle; and
b. a second phase including an ethylene oxide-containing polymer;
wherein the second phase is a continuous phase, and the organic microparticle is hollow, porous, or both; and
wherein the organic microparticle includes a styrene-containing polymer.

2. The polymeric electrolyte composition of claim 1, wherein the organic microparticle is hollow.

3. The polymeric electrolyte composition of claim 1, wherein the organic microparticle is porous.

4. The polymeric electrolyte composition of claim 3, wherein the ethylene oxide-containing polymer includes (i) a polyethylene oxide homopolymer, (ii) an ethylene oxide copolymer including one or more additional alkoxide monomers, or iii) both (i) and (ii).

5. The polymeric electrolyte composition of claim 3, wherein the ethylene oxide-containing polymer includes a mole fraction of ethylene oxide greater than about 0.80.

6. The polymeric electrolyte composition of claim 4, wherein the ethylene oxide-containing polymer is a polyethylene oxide homopolymer.

7. The polymeric electrolyte composition of claim 3, wherein the styrene-containing polymer is selected from the group consisting of a styrene-butadiene block copolymer, a styrene-isoprene block copolymer, a polystyrene homopolymer, a polystyrene random copolymer, a high impact polystyrene, a styrene-acrylonitrile block copolymer, an acrylonitrile-butadiene-styrene block copolymer, hydrogenated and partially hydrogenated analogues of the above isoprene and butadiene containing copolymers, or any combination thereof.

8. The polymeric electrolyte composition of claim 3, wherein the second phase includes an aprotic solvent.

9. The polymeric electrolyte composition of claim 8, wherein the organic microparticles includes hollow organic microparticles having a void fraction of about 0.30 or more.

10. The polymeric electrolyte composition of claim 9, wherein the polymeric electrolyte composition further comprises a lithium salt.

11. A polymeric electrolyte composition of claim 10 wherein the electrolyte includes oxygen atoms on the ethylene oxide-containing polymer and lithium ions from the lithium salt, such that the atomic ratio of oxygen to lithium is from about 2 to about 30.

12. The polymeric electrolyte composition of claim 10, wherein the ethylene-oxide containing polymer is a polyethylene oxide homopolymer, and the second phase includes the polyethylene oxide homopolymer, the lithium salt, and the aprotic solvent.

13. The polymeric electrolyte composition of claim 3, wherein the first phase is present at greater than about 5 percent by volume based on the total volume of the electrolyte composition and the second phase is present at greater than about 20 percent by volume based on the total volume of the electrolyte.

14. The polymeric electrolyte composition of claim 13, wherein
i) the ethylene oxide-containing polymer is characterized by a crystallinity in the neat state that is greater than about 60 weight percent
ii) the electrolyte contains less than about 40 weight percent of the organic microparticles and less than about 20 weight percent of the lithium salt, and
iii) the crystallinity of the ethylene oxide-containing polymer in the electrolyte is less than about 58 weight percent.

15. The polymeric electrolyte composition of claim 1, wherein,
i) the polymeric electrolyte is characterized by a shear modulus, G′, as measured by dynamic mechanical analysis according to ASTM 5270-08 at 30° C. and 1 rad/sec, that is at least 50 percent greater than the shear modulus of the ethylene oxide-containing polymer;
ii) the polymeric electrolyte is characterized by an ionic conductivity at 30° C. that is at least 200 percent greater than the ionic conductivity of a comparable electrolyte composition that is free of the porous organic particles and otherwise has the identical composition; or
iii) both (i) and (ii).

16. The polymeric electrolyte composition of claim 1, wherein the polymeric electrolyte composition exhibits a shear modulus, as measured by dynamical mechanical analysis according to ASTM D5279-08 at about 1 rad/sec and about 30° C., G′, and an ionic conductivity, as measured by AC impedance spectroscopy in a Solartron using an alternating current amplitude of about 10 mV at about 30° C., σ, such that
i. G′·σ is greater than about 20 (S/cm)(Pa); and
ii. G′ is from about 10³ to about 10⁹ Pa.

17. A secondary battery including a polymeric electrolyte composition of claim 1, wherein the battery is free of a porous separator.

18. A process for preparing a polymeric electrolyte composition of claim 1, wherein the process includes the step of mixing:
i) the organic microparticles wherein the organic microparticles includes a styrene-containing polymer having a glass transition temperature, as measured by dynamic mechanical analysis according to ASTM E1640-99, T_{gs};
ii) the ethylene oxide-containing polymer; and
iii) the lithium salt;
wherein the organic microparticles are maintained at a temperature less than T_{gs}.

19. A process of claim 18 wherein the organic microparticles are in a latex including at least about 20 weight percent of the organic microparticles and at least about 20 weight percent water; and the process includes a step of drying the composition.

20. The polymeric electrolyte composition of claim 3, wherein
the organic microparticles includes hollow organic microparticles having a void fraction of about 0.30 or more;
the ethylene oxide-containing polymer includes (i) a polyethylene oxide homopolymer, (ii) an ethylene oxide copolymer including one or more additional alkoxide monomers, or iii) both (i) and (ii), and the oxide-containing polymer includes a mole fraction of ethylene oxide greater than about 0.80;
the styrene-containing polymer is selected from the group consisting of a styrene-butadiene block copolymer, a styrene-isoprene block copolymer, a polystyrene homopolymer, a polystyrene random copolymer, a high impact polystyrene, a styrene-acrylonitrile block copolymer, an acrylonitrile-butadiene-styrene block copolymer, hydrogenated and partially hydrogenated analogues of the above isoprene and butadiene containing copolymers, or any combination thereof;
the first phase is present at greater than about 5 percent by volume based on the total volume of the electrolyte composition;
the second phase is present at greater than about 20 percent by volume based on the total volume of the electrolyte, and includes an aprotic solvent;
the polymeric electrolyte composition further comprises a lithium salt;
the polymeric electrolyte includes an amount of oxygen atoms on the ethylene oxide-containing polymer and an amount of lithium ions from the lithium salt, such that the atomic ratio of oxygen to lithium is from about 2 to about 30; and
the polymeric electrolyte composition exhibits a shear modulus, as measured by dynamical mechanical analysis according to ASTM D5279-08 at about 1 rad/sec and about 30° C., G′, and an ionic conductivity, as measured by AC impedance spectroscopy in a Solartron using an alternating current amplitude of about 10 mV at about 30° C., σ, such that G′·σ is greater than about 20 (S/cm)(Pa); and G′ is from about 10³ to about 10⁹ Pa.
